(19) United States
(12) Patent Application Publication
(10) Pub. No.: US 2002/0084096 A1
(43) Pub. Date: Jul. 4, 2002

(54) Electric wire coupling assembly

(76) Inventors: Wen Shin Chang, Chong Ho City (TW); Yeou Tong Chen, Chong Ho City (TW)

Correspondence Address: Wen Shin Chang, Yeou Tong Chen, 6F No. 440-2, Gin Pin Road, Chong Ho City, 235, TW

(21) Appl. No.: 09/752,946

(22) Filed: Dec. 28, 2000

(51) Int. Cl. H01R 4/00

(52) U.S. Cl. 174/92

(57) ABSTRACT

An electric wire coupling device includes one or more electric wires having one or more electric cables engaged and received in an outer rubber covering. One or more sockets each has a socket housing, and two conductor members secured in the socket housing and aligned with the socket orifices of the socket housing for receiving plugs. The electric wires and/or the sockets each has an adhesive material for attaching to the supporting wall without further fasteners. The socket may include a side opening for coupling to the other electric wires.

### BACKGROUND OF THE INVENTION

1. Field of the Invention

The present invention relates to a coupling device, and more particularly to an electric wire coupling assembly.

2. Description of the Prior Art

Typical electric wires include two conductor cables and a plastic outer covering engaged on the outer portion of the conductor cables. It is difficult to couple the typical electric wires together and to secure the typical electric wires to the house buildings.

The present invention has arisen to mitigate and/or obviate the afore-described disadvantages of the conventional electric wires.

### SUMMARY OF THE INVENTION

The primary objective of the present invention is to provide an electric wire coupling assembly for easily securing or attaching to the walls or the corners of the house buildings.

In accordance with one aspect of the invention, there is provided an electric wire coupling assembly comprising at least one electric wire body including at least one electric cable engaged therein, at least one socket including at least one socket housing, and two conductor members secured in the socket housing, the socket housing including two socket orifices aligned with the conductor members, and an adhesive material provided on the electric wire body for attaching the electric wire body to a supporting wall.

The socket includes an opening formed therein for receiving the electric wire body, and two conductor elements secured to the conductor members and each having a first end located close to the opening of the socket for coupling to the electric wire body.

One or more corner members are further provided and each includes an L-shape, and each includes two second conductor members which are also L-shaped for attaching to the corner areas of the house buildings.

Further objectives and advantages of the present invention will become apparent from a careful reading of a detailed description provided hereinbelow, with appropriate reference to accompanying drawings.

### BRIEF DESCRIPTION OF THE DRAWINGS

FIGS. 1, 2, 3 are partial exploded views of an electric wire coupling assembly in accordance with the present invention;

FIG. 4 is a partial perspective view of the electric wire coupling assembly;

FIG. 5 is a partial perspective view illustrating the other embodiment of the electric wire body for the electric wire coupling assembly;

FIGS. 6 and 7 are partial exploded views illustrating the other embodiments of the electric wire coupling member and socket for the electric wire coupling assembly; and

FIGS. 8 and 9 are partial perspective views illustrating the operations of the electric wire coupling assembly.

### DETAILED DESCRIPTION OF THE PREFERRED EMBODIMENT

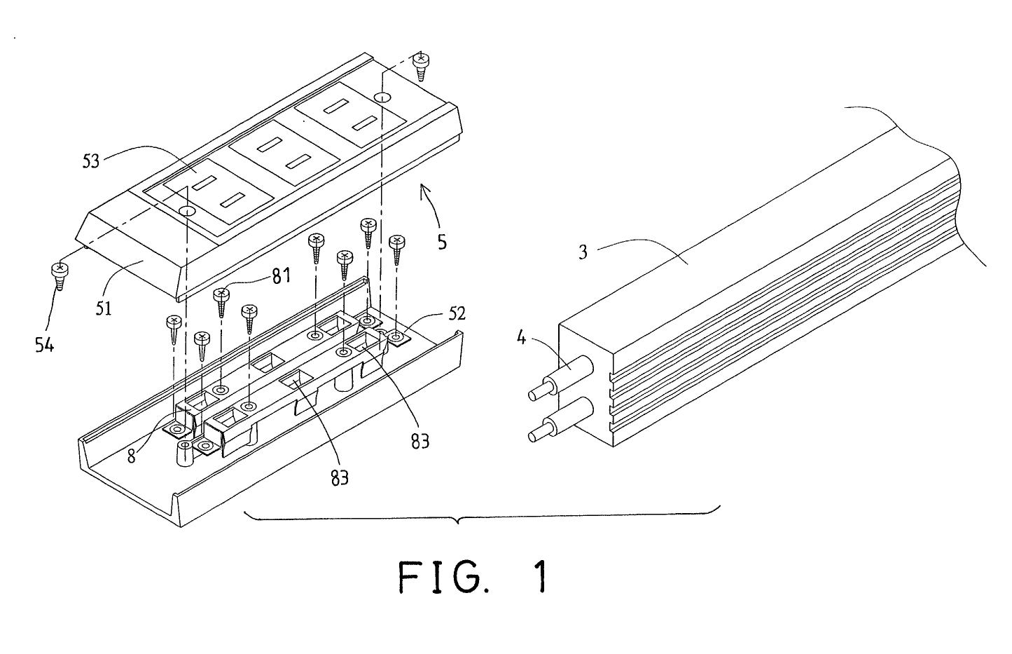

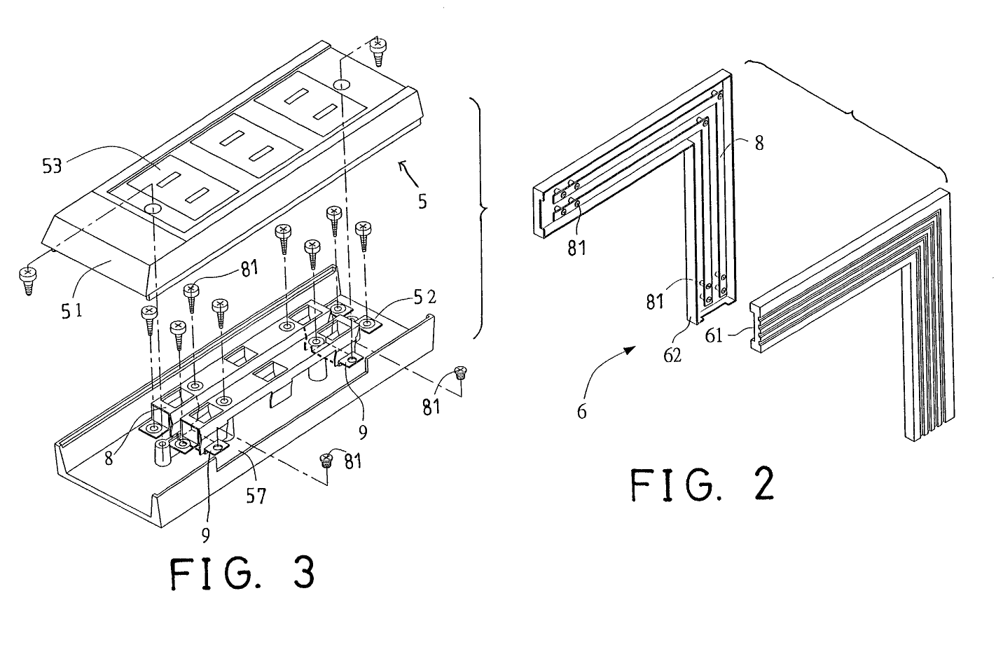

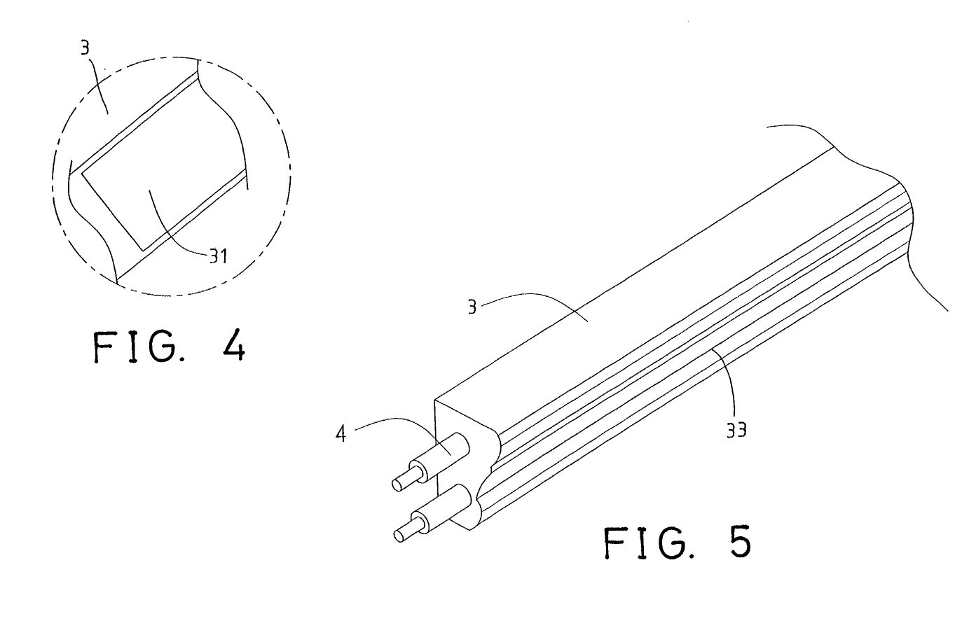

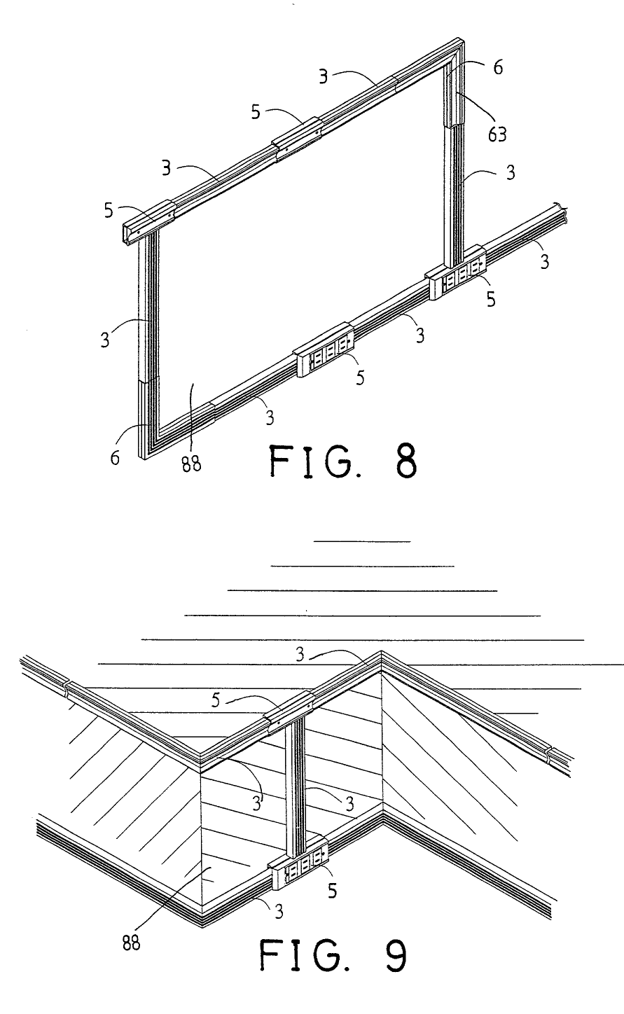

Referring to the drawings, and initially to FIGS. 1-4, an electric wire coupling assembly in accordance with the present invention comprises an electric wire body 3 including one or more, particularly two electric cables 4 engaged therein by such as the molding process while the electric wire body 3 is molded or formed. The electric wire body 3 includes one of its surfaces, such as the rear surface thereof having an adhesive layer or material 31 applied thereon (FIG. 4), for allowing the electric wire body 3 to be easily attached and secured onto the corners or the walls 88 of the house buildings (FIGS. 8, 9), without any further fasteners. As shown in FIG. 5, the electric wire body 3 may include a spatial outer decorative configuration 33.

The electric wire coupling assembly includes a socket 5 having one or two socket housings 51, 52 secured together with such as the fasteners 54. Two conductor members 8 are secured in the socket 5 with such as the fasteners 81, and preferably parallel to each other, and include one or more pairs of socket apertures 83 formed therein for plugging with the plugs or the like. The cover housing 51 includes one or more pairs of socket orifices 53 formed therein and aligned with the socket apertures 83 of the conductor members 8 for receiving the prongs of the plugs or the like. The electric cables 4 may be secured to the conductor members 8 with the fasteners 81 or the like. The socket 5 may be coupled between the electric wire bodies 3 (FIGS. 8, 9).

As shown in FIG. 3, the socket 5 may include a side opening 57 formed therein for receiving the electric wire bodies 3. Two further conductor elements 9 are secured and coupled to the two conductor members 8 respectively and each has one end located close to the opening 57 of the socket 5 for receiving and coupling to the electric wire bodies 3, best shown in FIGS. 8, 9. As shown in FIG. 7, the socket 5 may include a spatial outer decorative configuration 58. The socket 5 includes one of its surfaces, such as the rear surface thereof having an adhesive layer or material applied thereon for allowing the socket to be easily attached and secured onto the walls of the house buildings.

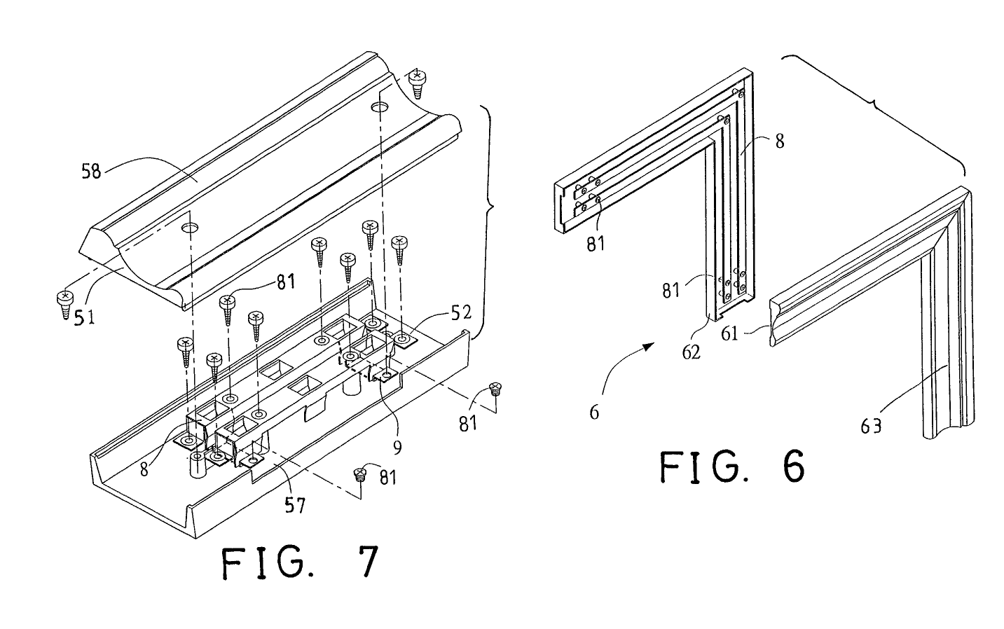

The electric wire coupling assembly further includes one or more corner members 6 (FIG. 2) each having two casings 61, 62 secured together with such as the adhesive materials, fasteners or with such as the welding process or the like, and each having two conductor members 8 secured therein. The corner members 6 and the conductor members 8 each has an L-shape for attaching to the corners of the house buildings (FIG. 8). As shown in FIG. 6, the corner members 6 may include a spatial outer decorative configuration 63. The corner member 6 includes one of its surfaces, such as the rear surface thereof having an adhesive layer or material applied thereon for allowing the corner member 6 to be easily attached and secured onto the corners or the walls 88 of the house buildings.

In operation, as shown in FIGS. 8 and 9, the electric wire bodies 3 and/or the sockets 5 and/or the corner members 6 may be easily and quickly attached and secured to the walls 88 of the house buildings.

Accordingly, the electric wire coupling assembly in accordance with the present invention may be easily secured or attached to the walls or the corners of the house buildings.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An electric wire coupling assembly comprising:
at least one electric wire body including at least one electric cable engaged therein,
at least one socket including at least one socket housing, and two conductor members secured in said at least one socket housing, said at least one socket housing including two socket orifices formed therein and aligned with said conductor members, and
an adhesive material provided on said at least one electric wire body for attaching said at least one electric wire body to a supporting wall.

2. The electric wire coupling assembly according to claim 1, wherein said at least one socket includes an opening formed therein for receiving said at least one electric wire body, and two conductor elements secured to said conductor members respectively and each having a first end located close to said opening of said at least one socket for coupling to said at least one electric wire body.

3. The electric wire coupling assembly according to claim 1 further comprising at least one corner member including an L-shape and two second conductor members secured in said at least one corner member, said second conductor members each includes an L-shape.
